(19) United States
(12) Patent Application Publication
(10) Pub. No.: US 2016/0365665 A1
(43) Pub. Date: Dec. 15, 2016

(54) CONNECTOR

(71) Applicant: Sumitomo Wiring Systems, Ltd., Yokkaichi (JP)

(72) Inventors: Takahiro Chikusa, Yokkaichi (JP); Shinji Iihoshi, Yokkaichi (JP)

(21) Appl. No.: 15/161,357

(22) Filed: May 23, 2016

(30) Foreign Application Priority Data
Jun. 9, 2015 (JP) 2015-117013

(51) Int. Cl. H01R 13/506

(52) U.S. Cl. CPC H01R 13/506

(57) ABSTRACT

A connector is miniaturized and while still preventing damage to locking lances. Deflectable first and second locking lances (19, 79) configured to lock first and second terminal fittings (11, 61) are arranged to be exposed on first and second facing surfaces (15, 75) of first and second housings (10, 60). When the first and second housings 10, 60 are assembled, the first and second locking lances (19, 79) are arranged back-to-back with each other. Surfaces of the first and second locking lances (19, 79) facing the first and second cavities (17, 77) on tip parts in a projecting direction are continuous without any step and include locking surfaces (23, 83) configured to lock the first and second terminal fittings (11, 61) on tips in the projecting direction.

### BACKGROUND

1. Field of the Invention

The present invention relates to a connector.

2. Description of the Related Art

A connector disclosed in Japanese Unexamined Patent Publication No. H10-162888 includes two housing units to be laminated to each other. Side surfaces of the both housing units are coupled to each other via a flexible band. Out of the both housing units, one housing unit includes a pair of front and rear deflectable laminating/engaging pieces provided on opposite side surfaces thereof and projecting toward the other housing unit. Each laminating/engaging piece maintains a coupled state of the both housing units by engaging a hook portion on the tip with an engaging groove provided on the other housing unit.

Information on a mating housing as a connection partner of the both housing units is not indicated at all in Japanese Unexamined Patent Publication No. H10-162888. However, if the mating housing is assumed to include a receptacle into which the both housing units are to be collectively fitted, each laminating/engaging piece is expected to enter the receptacle at the time of connection. Thus, it is difficult for an operator to perform a connecting operation to the mating housing while placing his fingers on the laminating/engaging pieces paired on the opposite side surfaces of the housing unit. As a result, structures for placing fingers have to be ensured separately from the laminating/engaging pieces on the opposite side surfaces of the housing unit, which may complicate the structure.

The present invention was completed based on the above situation and aims to provide a connector capable of avoiding the complication of a structure.

### SUMMARY

The present invention is directed to a connector with two housings to be assembled in a mutually laminated state, wherein the both housings respectively include facing surfaces facing each other at the time of assembling and are connectable to and separable from a mating housing in an assembled state, one housing out of the both housings includes deflectable lock portions provided on opposite sides intersecting with the facing surface, the other housing out of the both housings includes lock receiving portions provided on opposite sides intersecting with the facing surface and configured to maintain the assembled state of the both housings by being resiliently locked from outer sides by the lock portions, and the lock portions include exposed surfaces exposed to outside with the both housings connected to the mating housing and enabling fingers to be placed thereon during connection to and separation from the mating housing.

Since the lock portions have both a function of maintaining the assembled state of the both housings and a function of advancing connecting and separating operations by having fingers placed thereon during connection to and separation from the mating housing, the configuration can be simplified as compared to the case where the both functions are provided on separate parts.

### BRIEF DESCRIPTION OF THE DRAWINGS

FIG. 1 is a front view showing a state where first and second housings are assembled in a laminated state in a connector according to an embodiment of the present invention.

FIG. 2 is a view showing a state where the first and second housings in an assembled state are cut at a part corresponding to first and second retaining portions and first and second retention receiving portions.

FIG. 3 is a view showing a state where the first and second housings in the assembled state are cut at a part corresponding to lock portions and lock receiving portions.

FIG. 4 is a side view showing a state where the first and second housings are assembled in the laminated state and connected to a mating housing.

FIG. 5 is a view showing a state where the first and second housings in the assembled state are cut along first and second cavities.

FIG. 6 is a front view of the first housing.

FIG. 7 is a rear view of the first housing.

FIG. 8 is a side view of the first housing.

FIG. 9 is a plan view of the first housing.

FIG. 10 is a front view of the second housing.

FIG. 11 is a bottom view of the second housing.

FIG. 12 is a view showing a state where the second housing is cut at a part corresponding to a second cut portion.

FIG. 13 is an enlarged view showing a state where the first and second housings in the assembled state are cut at a part corresponding to first and second cut portions.

FIG. 14A is an enlarged view showing a state where a tip part of a jig is inserted into the second cut portion to be engageable with a rear end part of a second locking lance and FIG. 14B is an enlarged view showing a state where the tip part of the jig is slid along a second guide edge of the second cut portion.

### DETAILED DESCRIPTION

Preferred embodiments of the present invention are described below.

The mating housing includes a receptacle externally fittable to the both housings, and the lock portions have such a thickness as to face an opening end of the receptacle with the both housings connected to the mating housing and end surfaces in a thickness direction serve as the exposed surfaces. According to this, the exposed surfaces of the lock portions are easily recognized as finger placing surfaces during connection to and separation from the mating housing. Further, interference with surrounding structures is more easily avoided by placing fingers on the exposed surfaces of the lock portions and advancing the connecting and separating operations.

The lock portions are arranged on a rear end part of the one housing in a connecting direction of the both housings, and the one housing includes bridge portions linking a front end part of the one housing in the connecting direction of the both housings and projecting end parts of the lock portions. Since the exposed surfaces of the lock portions are exposed to outside with the both housings connected to the mating housing, if the lock portion is caught by an external matter such as a wire from outside, the lock portion may be opened and deformed, thereby being fractured and broken. In that respect, since the bridge portions are mounted between the front end part in the connecting direction of the both housings and the projecting end parts of the lock portions according to the above configuration, the lock portions can be prevented from being opened and deformed and can be reinforced.

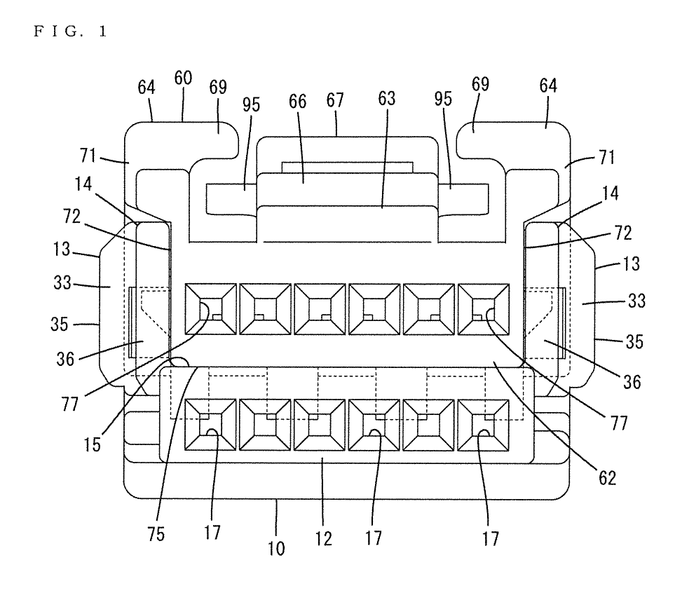

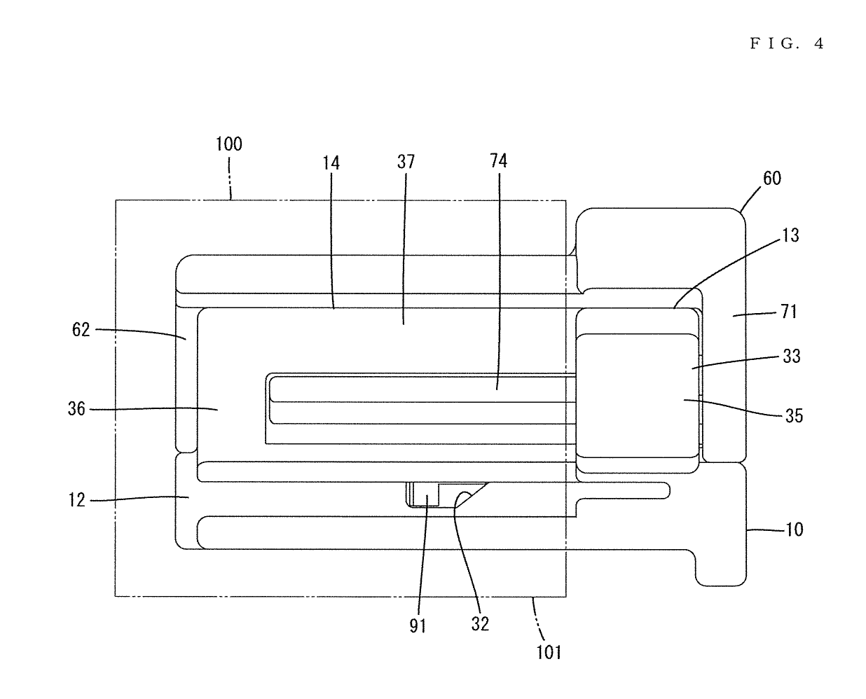

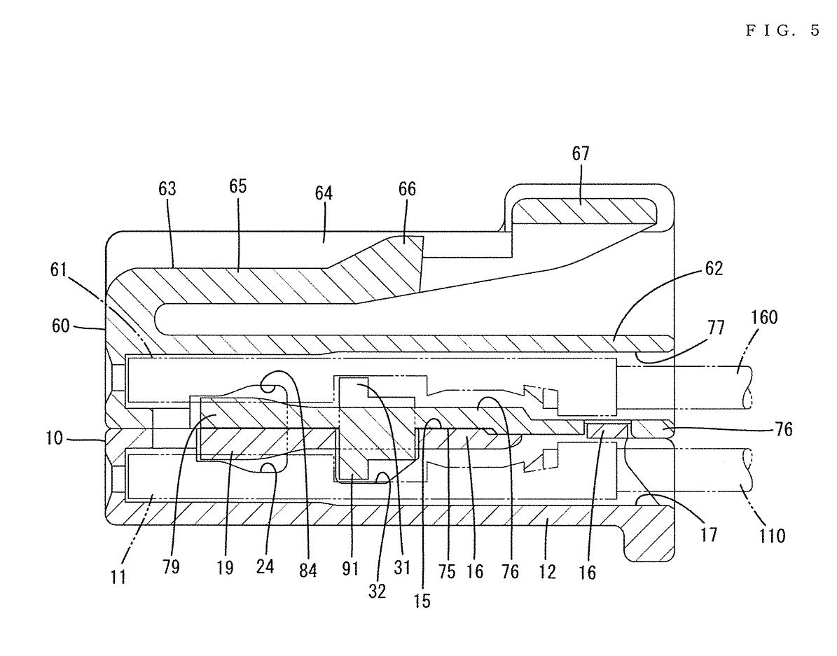

Hereinafter, an embodiment of the present invention is described with reference to FIGS. 1 to 14. A connector of this embodiment includes, as shown in FIG. 5, first and second housings 10, 60 to be assembled in a mutually laminated state and first and second terminal fittings 11, 61 to be respectively accommodated into the first and second housings 10, 60. As shown in FIG. 4, the first and second housings 10, 60 are connectable to a mating housing 100 from front (left side in FIG. 4) in a state assembled with each other.

As shown in FIG. 5, the first and second terminal fittings 11, 61 are all shaped to be long and narrow in a front-back direction as a whole such as by bending an electrically conductive metal plate, and formed into the same shape. Rear end parts of the first and second terminal fittings 11, 61 are crimped and connected to end parts of wires 110, 160. Front end parts of the first and second terminal fittings 11, 61 are box-shaped and, when the first and second housings 10, 60 are properly connected, male tabs of unillustrated mating terminal fittings are inserted thereinto to be electrically connected.

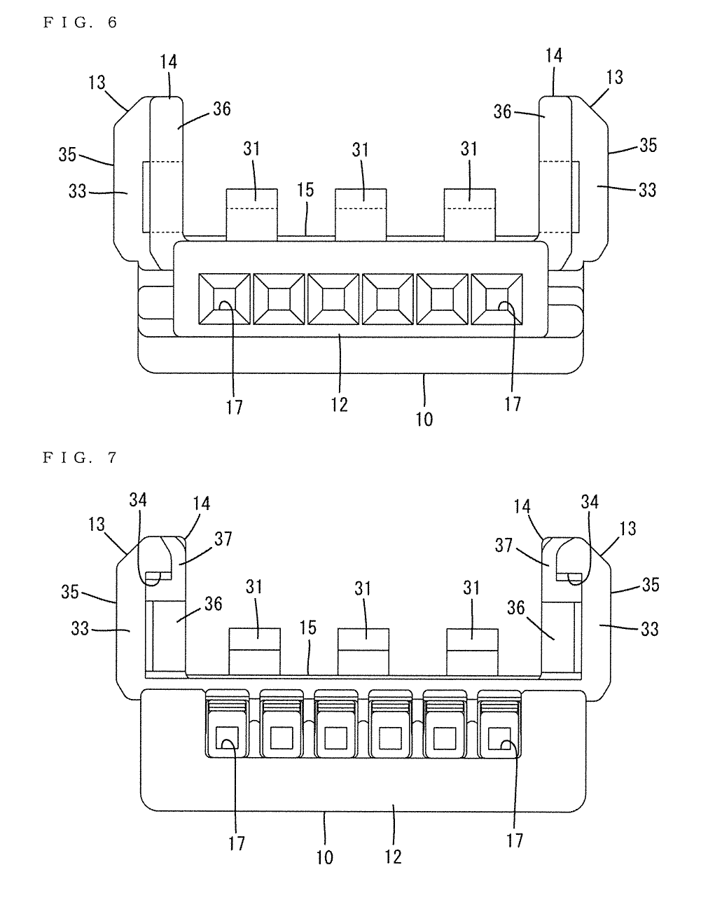

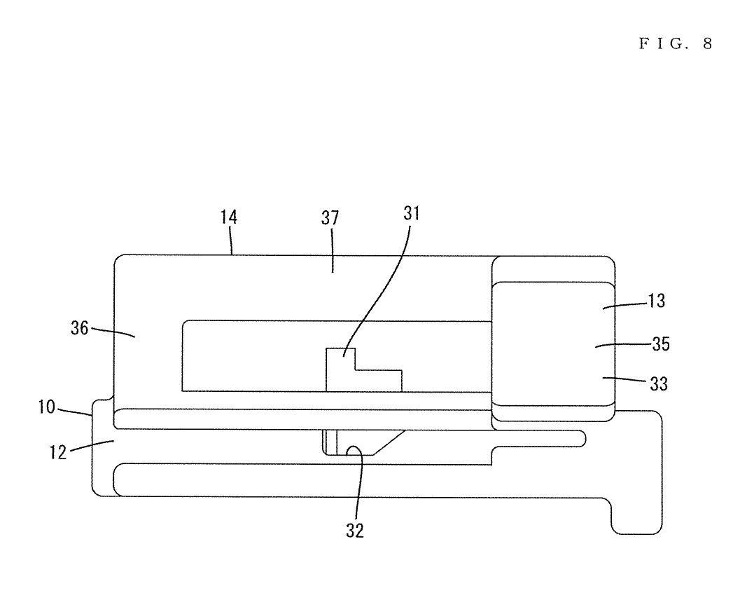

The first housing 10 is made of synthetic resin and, as shown in FIGS. 1 to 5, arranged below the second housing 60 when the first and second housings 10, 60 are assembled. As shown in FIGS. 6 and 8, the first housing 10 includes a first housing main body 12 in the form of a flat rectangular block, a pair of lock portions 13 projecting upwardly from upper edge parts of the rear ends of both left and right sides of the first housing main body 12 and a pair of bridge portions 14 mounted to link upper end parts (projecting end parts) of the both lock portions 13 and upper edge parts of the front ends of the both left and right sides of the first housing main body 12.

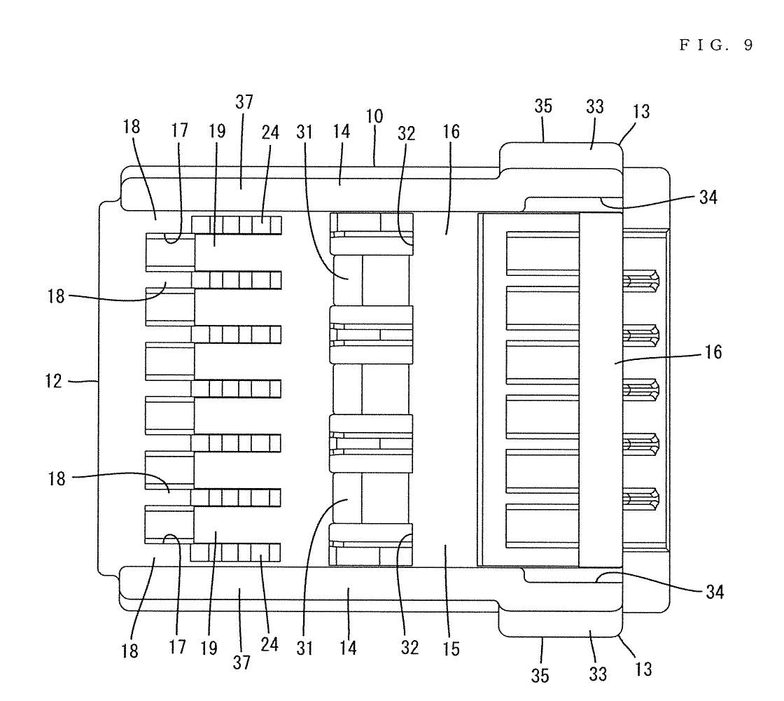

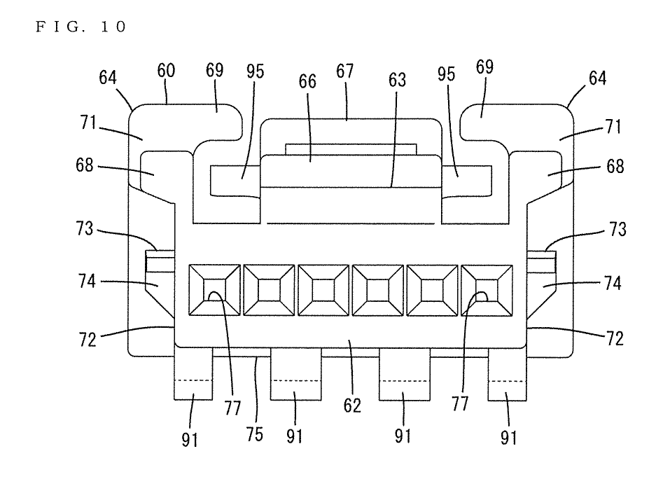

As shown in FIG. 9, the upper surface of the first housing main body 12 serves as a first facing surface 15 arranged to face the second housing 60 at the time of assembling. The both lock portions 13 and the both bridge portions 14 are respectively arranged while being paired at left and right sides across the first facing surface 15. The first facing surface 15 of the first housing main body 12 is closed by first covering walls 16 in the form of rectangular plates laid in a lateral direction. A plurality of first covering walls 16 are arranged while being spaced apart in the front-back direction (see FIG. 5).

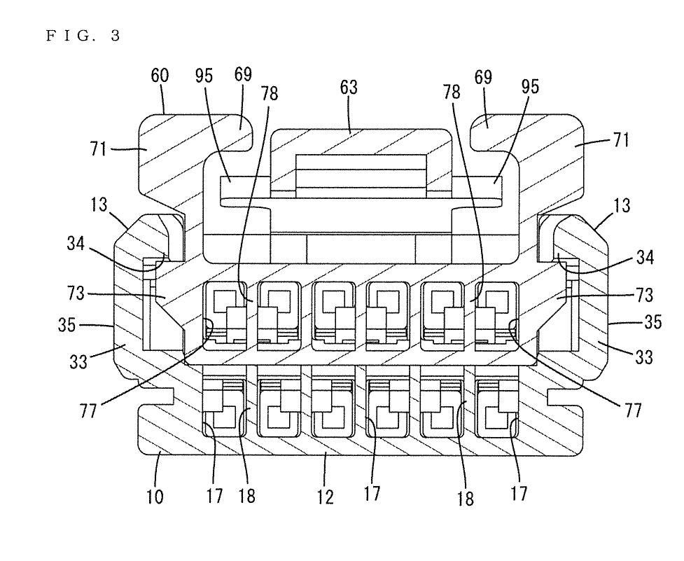

As shown in FIGS. 6 and 9, a plurality of first cavities 17 are laterally arranged in a row in the first housing main body 12. As shown in FIG. 5, the first terminal fitting 11 is inserted into the first cavity 17 from behind. As shown in FIGS. 3 and 9, the first cavities 17 laterally adjacent to each other and left and right outer sides of the first cavities 17 arranged on both left and right ends are partitioned by thin first partition walls 18. Upper ends of each first cavity 17 and each first partition wall 18 are open at front and rear sides across each first covering wall 16 on the first facing surface 15.

As shown in FIG. 5, a cantilever-like first locking lance 19 projecting forward from the front end of the first covering wall 16 is arranged to project into the first cavity 17 of the first housing main body 12. The first locking lance 19 is resiliently lockable to the first terminal fitting 11. The outer surface (upper surface, back surface) of the first locking lance 19 is a flat surface extending along the front-back direction and is arranged to be exposed on the first facing surface 15 as shown in FIG. 9. The outer surface of the first locking lance 19 is continuous with the outer surface (first facing surface 15) of the first covering wall 16 without any step in the front-back direction.

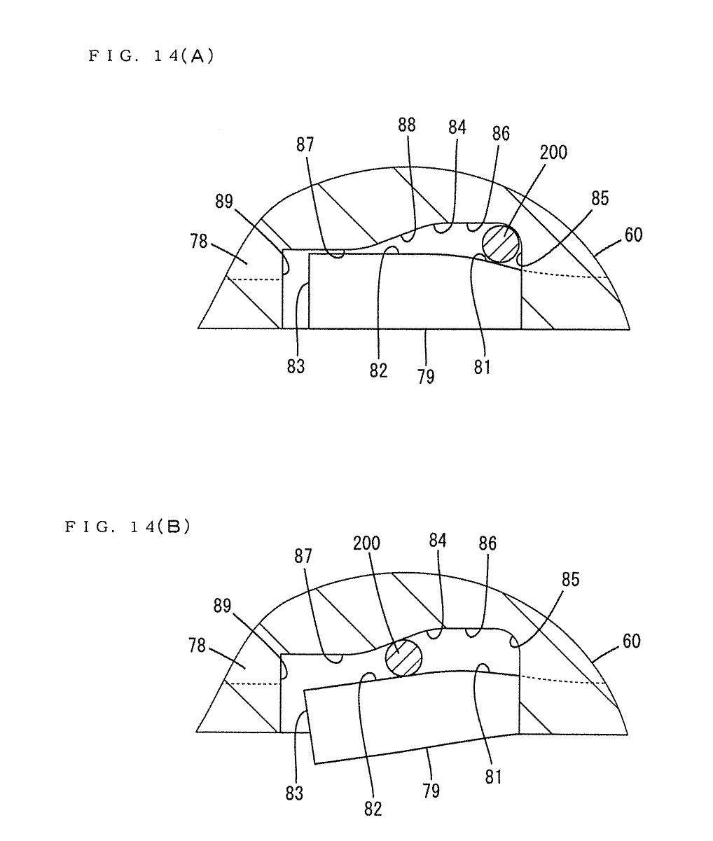

Further, as shown in FIG. 13, the inner surface (surface facing the first cavity 17) of the first locking lance 19 is composed of a first inclined part 21 moderately inclined downwardly to the front from the inner surface of the first covering wall 16 and a first straight part 22 extending substantially straight in the front-back direction from the front end of the first inclined part 21 to the front end (tip in a projecting direction) of the first locking lance 19. The inner surface of the first locking lance 19 is continuous without any step in the front-back direction from the first inclined part 21 to the first straight part 22. The front end surface of the first locking lance 19 serves as a first locking surface 23 extending substantially along a vertical direction and is connected substantially at a right angle to the front end of the first straight part 22.

As shown in FIG. 9, each first partition wall 18 is provided with a first cut portion 24 at a position laterally adjacent to the first locking lance(s) 19. As shown in FIG. 13, the first cut portion 24 is in the form of a recess open on the upper end of the first partition wall 18 and includes a first guide edge 25 extending from a rear end side of the first locking lance 19 serving as a supporting point of deflection toward a front end side (free end side) of the first locking lance 19. A jig 200 (see FIGS. 14A and 14B) for releasing a locking state of the first locking lance 19 is inserted into the first cut portion 24 and a releasing operation of the jig 200 is guided along the first guide edge 25.

Specifically, as shown in FIG. 13, the first guide edge 25 includes a first rear edge part 26 deeply recessed to a position lower than the first inclined part 21 in the vertical direction, a first front edge part 27 recessed to substantially the same height position as the first straight part 22 and a first oblique edge part 28 inclined upwardly from the first rear edge part 26 to the first front edge part 27. The rear end of the first rear edge part 26 is arranged substantially at the same position as the rear end part of the first locking lance 19 in the front-back direction, and the front end of the first front edge part 27 is arranged before that of the first locking lance 19. The first cut portion 24 includes a first stopper edge 29 extending substantially along the vertical direction from the front end of the first front edge part 27 to the upper end of the first partition wall 18.

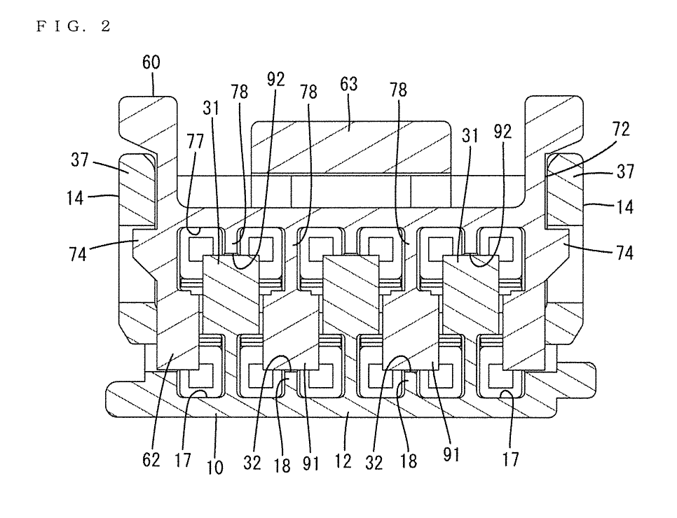

As shown in FIG. 9, the first facing surface 15 of the first covering wall 16 is provided with a plurality of first retaining portions 31 and a plurality of first retention receiving portions 32 in a substantially central part of the first housing main body 12 in the front-back direction. The respective first retaining portions 31 and the respective first retention receiving portions 32 are laterally alternately arranged to correspond to the respective first partition walls 18. Specifically, the first retaining portion 31 is substantially in the form of a rectangular block projecting upwardly of the corresponding partition wall 18 as shown in FIG. 2 and the front surface is arranged to extend substantially along the vertical direction as shown in FIG. 8. As shown in FIG. 2, the first retention receiving portion 32 recesses the upper end of the corresponding partition wall 18. The first retaining portion 31 is inserted into a second retention receiving portion 92 to be described later and retains and locks the second terminal fitting 61 inserted into a later-described second cavity 77 of the second housing 60, and the first retention receiving portion 32 functions to receive a second retaining portion 91 to be described later and bring the second retaining portion 91 to a position where the second retaining portion 91 is lockable to the first terminal fitting 11 as shown in FIG. 5.

As shown in FIGS. 6 to 8, the both lock portions 13 are composed of lock main bodies 33 in the form of rectangular plates standing upwardly from upper edge parts of the rear ends of the both left and right sides of the first housing main body 12 and lock projections 34 in the form of claws protruding inwardly from the upper ends (standing ends) of the lock main bodies 33. The both lock portions 13 resiliently lock later-described lock receiving portions 73, whereby the assembled state of the first and second housings 10, 60 is maintained.

As shown in FIGS. 6, 7 and 9, the lock main bodies 33 stand upwardly after protruding laterally outwardly from the upper end of the first housing main body 12. An exposed surface 35 extending along the vertical direction and the front-back direction is provided on the outer surface of the lock main body 33. The exposed surface 35 of the lock main body 33 is arranged at a position projecting laterally outwardly of the side surface of the first housing main body 12 and, as shown in FIG. 4, arranged to be exposed to the outside of the mating housing 100 with the first and second housings 10, 60 properly connected to the mating housing 100. As shown in FIG. 7, the inner surface of the lock main body 33 is arranged along the vertical direction and the front-back direction and arranged substantially at the same position as the side surface of the first housing main body 12 in the lateral direction.

The lock projection 34 is in the form of a rectangular rib projecting inwardly along the lateral direction as shown in FIG. 7 and extending substantially over the entire length in the front-back direction along the upper end edge of the lock main body 33 as shown in FIG. 9.

As shown in FIG. 8, the bridge portions 14 are composed of front wall portions 36 standing upwardly from upper edge parts of the front ends of the both left and right sides of the first housing main body 12 and bridging wall portions 37 extending in the front-back direction and having the front ends coupled to the front wall portions 36 and the rear ends coupled to upper end parts of the lock main bodies 33. Both the front wall portions 36 and the bridging wall portions 37 are in the form of rectangular plates extending along the vertical direction and the front-back direction. The bridge portions 14 function to reinforce the lock portions 13 and regulate inadvertent widening of the lock portions 13.

As shown in FIG. 9, the rear end of the bridging wall portion 37 is integrally coupled to the lock projection 34 and the inner surface thereof is connected to the inner surface of the lock projection 34 via a step to be located more inwardly than the inner surface of the lock projection 34. Further, the outer surface of the bridge portion 14 is arranged at a position inwardly of the exposed surface 35 of the lock main body 33.

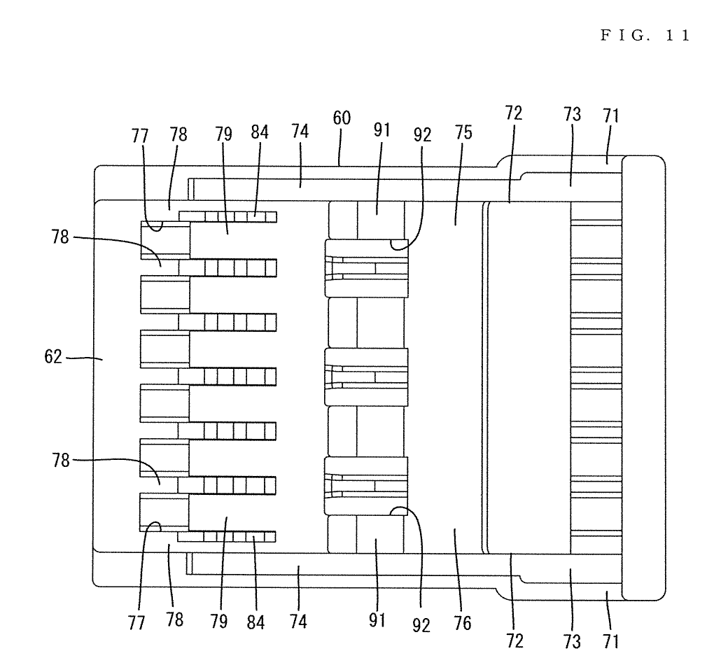

Next, the second housing 60 is described. The second housing 60 is made of synthetic resin and includes, as shown in FIG. 10, a second housing main body 62 in the form of a flat rectangular block, a lock arm 63 disposed on a lateral central part of the upper surface of the second housing main body 62 and a pair of protection walls 64 disposed at left and right sides across the lock arm 63 on the upper surface of the second housing main body 62.

As shown in FIG. 5, the lock arm 63 includes an arm main body 65 extending backward after standing up from the front end of the upper surface of the second housing main body 62, a locking protrusion 66 projecting upwardly at an intermediate position of the arm main body 65 in the front-back direction and a releasing portion 67 arranged to be slightly higher at a rear end part of the arm main body 65.

Here, the first and second housings 10, 60 in the assembled state are fitted into a receptacle 101 of the mating housing 100 (see FIG. 4). Then, after the arm main body 65 is deflected, the locking protrusion 66 resiliently locks the receptacle 101 and the first and second housings 10, 60 are maintained in a state where separation from the mating housing 100 is regulated. Further, the locking state of the locking protrusion 66 can be released and the first and second housings 10, 60 can be pulled apart from each other by pressing the releasing portion 67.

As shown in FIG. 10, the both protection walls 64 include a pair of standing walls 68 standing from both left and right end parts of the upper surface of the second housing main body 62 and a pair of regulating pieces 69 protruding inwardly from the upper ends of the standing walls 68. The both standing walls 68 are in the form of plate walls extending along the front-back direction and can cover side surfaces of the lock arm 63. The both regulating pieces 69 come into contact with receiving pieces 95 protruding toward both left and right sides from the arm main body 65 when the arm main body 65 is going to be deflected in an upward direction, which is opposite to a proper direction, whereby excessive deflection and deformation of the arm main body 65 in a reverse direction can be regulated.

A pair of ribs 71 L-shaped in a side view are provided in ranges from upper end parts to rear end parts of the both protection walls 64 on the both left and right side surfaces of the second housing 60 (FIG. 4), and a pair of mounting recesses 72 open forward and downward are provided inwardly of the both ribs 71 as shown in FIG. 1. When the first and second housings 10, 60 are assembled, the bridge portions 14 and the lock projections 34 of the lock portions 13 are fitted and mounted into the mounting recesses 72.

As shown in FIGS. 10 and 11, the lock receiving portion 73 is provided to project on a rear end part of the back surface of the mounting recess 72 of the second housing 60. The lock receiving portion 73 is in the form of a rib extending in the front-back direction and the upper surface thereof is arranged to be flat in the lateral direction. Further, a fitting portion 74 is provided on the back surface of the mounting recess 72 of the second housing 60. The fitting portion 74 is in the form of a rib extending in the front-back direction and longer than the lock receiving portion 73 and the rear end thereof is integrally coupled to the lock receiving portion 73. The upper surface of the fitting portion 74 is arranged at a position slightly lower than the upper surface of the lock receiving portion 73.

As shown in FIGS. 1 and 5, the lower surface of the second housing 60 serves as a second facing surface 75 to be arranged to face the first housing 10 at the time of assembling. As shown in FIG. 11, the second facing surface 75 of the second housing 60 is closed by second covering walls 76 in the form of rectangular plates laid in the lateral direction.

A plurality of second cavities 77 are laterally arranged in a row in the second housing main body 62. As shown in FIG. 5, the second terminal fitting 61 is inserted into the second cavity 77 from behind. As shown in FIG. 11, the second cavities 77 laterally adjacent to each other and left and right outer sides of the second cavities 77 arranged on both left and right ends are partitioned by thin second partition walls 78. Upper ends of each second cavity 77 and each second partition wall 78 are open at both front and rear sides across the second covering walls 76 on the second facing surface 75.

As shown in FIG. 5, a cantilever-like second locking lance 79 projecting forward from the front end of the second covering wall 76 is arranged to project into the second cavity 77 of the second housing main body 62. The second locking lance 79 is resiliently lockable to the second terminal fitting 61. The outer surface (lower surface, back surface) of the second locking lance 79 is a flat surface extending along the front-back direction and is arranged to be exposed on the second facing surface 75 as shown in FIG. 11. The outer surface of the second locking lance 79 is continuous with the outer surface (second facing surface 75) of the second covering wall 76 without any step in the front-back direction.

As shown in FIG. 13, the inner surface (surface facing the second cavity 77) of the second locking lance 79 is composed of a second inclined part 81 moderately inclined upwardly to the front from the inner surface of the second covering wall 76 and a second straight part 82 extending substantially straight in the front-back direction from the front end of the second inclined part 81 to the front end (tip in a projecting direction) of the second locking lance 79. The inner surface of the second locking lance 79 is continuous without any step in the front-back direction from the second inclined part 81 to the second straight part 82. The front end surface of the second locking lance 79 serves as a second locking surface 83 extending substantially along the vertical direction and is connected substantially at a right angle to the front end of the second straight part 82.

As shown in FIG. 13, the first and second locking lances 19, 79 are mutually identically shaped and sized and, when the first and second housings 10, 60 are assembled, vertically symmetrically arranged across the first and second facing surfaces 15, 75.

As shown in FIG. 11, each second partition wall 78 is provided with a second cut portion 84 at a position laterally adjacent to the second locking lance(s) 79. As shown in FIG. 13, the second cut portion 84 is in the form of a recess open on the lower end of the second partition wall 78 and includes a second guide edge 85 extending from a rear end side of the second locking lance 79 serving as a supporting point of deflection toward a front end side (free end side) of the second locking lance 79. The jig 200 (see FIGS. 14A and 14B) for releasing a locking state of the second locking lance 79 is inserted into the second cut portion 84 and guided along the second guide edge 85.

Specifically, as shown in FIG. 13, the second guide edge 85 includes a second rear edge part 86 deeply recessed to a position upper than the second inclined part 81 in the vertical direction, a second front edge part 87 recessed to substantially the same height position as the second straight part 82 and a second oblique edge part 88 inclined downwardly from the second rear edge part 86 to the second front edge part 87. The rear end of the second rear edge part 86 is arranged substantially at the same position as a rear end part of the second locking lance 79 in the front-back direction, and the front end of the second front edge part 87 is arranged before that of the second locking lance 79. The second cut portion 84 includes a second stopper edge 89 extending substantially along the vertical direction from the front end of the second front edge part 87 to the lower end of the second partition wall 78.

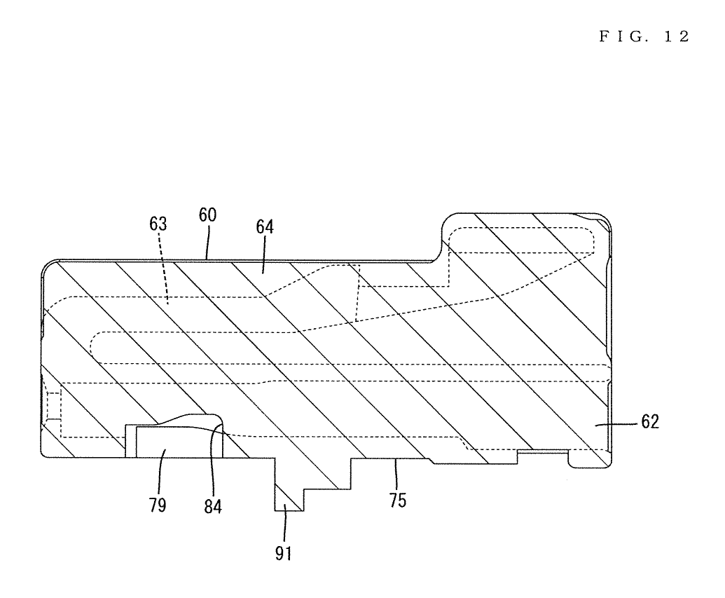

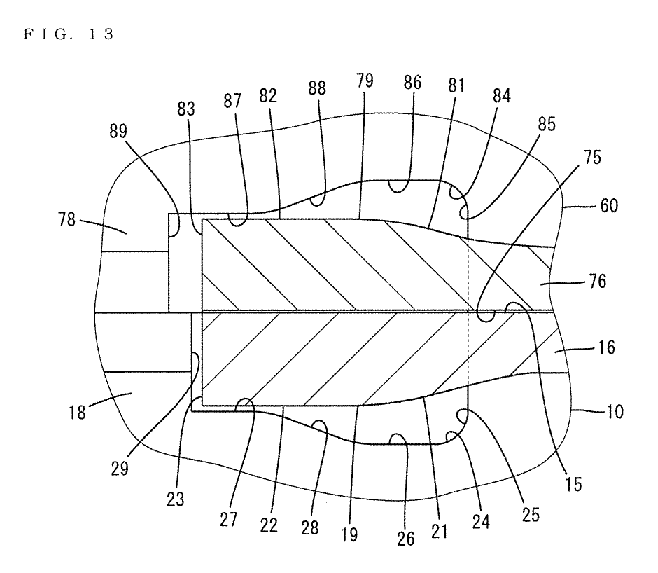

As shown in FIG. 11, the second facing surface 75 of the second covering wall 76 is provided with a plurality of second retaining portions 91 and a plurality of second retention receiving portions 92 in a substantially central part of the second housing main body 62 in the front-back direction. The respective second retaining portions 91 and the respective second retention receiving portions 92 are laterally alternately arranged to correspond to the respective second partition walls 78. Specifically, the second retaining portion 91 is substantially in the form of a rectangular block projecting downwardly of the corresponding partition wall 78 as shown in FIG. 2 and the front surface is arranged to extend substantially along the vertical direction as shown in FIGS. 5 and 12. As shown in FIG. 2, the second retention receiving portion 92 recesses the lower end of the corresponding partition wall 78. Each second retaining portion 91 is arranged at a position corresponding to each first retention receiving portion 32 and each second retention receiving portion 92 is arranged at a position corresponding to each first retaining portion 31.

As shown in FIG. 2, the first retaining portion 31 is fitted and inserted into the second retention receiving portion 92 and the second retaining portion 91 is fitted and inserted into the first retention receiving portion 32 when the first and second housings 10, 60 are assembled. Then, as shown in FIG. 5, the first and second retaining portions 31, 91 are arranged to face and be lockable to the second and first terminal fittings 61, 11, with the result that backward detachment of the first and second terminal fittings 11, 61 from the first and second cavities 17, 77 is reliably regulated. In this case, since the first retaining portions 31 are fitted into the second retention receiving portions 92 and inserted over the adjacent second cavities 77 and the second retaining portions 91 are fitted into the first retention receiving portions 32 and inserted over the adjacent first cavities 17, it is possible to efficiently lock the first and second terminal fittings 11, 61 while realizing space saving.

This embodiment is structured as described above. Next, functions and effects are described.

When the first housing 10 is in a single state, the first terminal fittings 11 are inserted into the first cavities 17 of the first housing main body 12. In the process of inserting the first terminal fitting 11, the front end part of the first terminal fitting 11 slides on the first inclined part 21 of the first locking lance 19 and the first locking lance 19 is deflected and deformed with the rear end thereof as a supporting point. At this time, the first locking lance 19 is deflected and deformed to project outwardly from the first facing surface 15. When the insertion of the first terminal fitting 11 is completed, the first terminal fitting 11 is stopped in contact with the front wall of the first housing main body 12, the first locking lance 19 resiliently returns and the first locking surface 23 of the first locking lance 19 is arranged to face and be lockable to the front end part of the first terminal fitting 11. In this way, the first terminal fitting 11 is held in the first cavity 17 of the first housing main body 12 in a state where backward detachment is regulated. Note that the second terminal fitting 61 is inserted into the second cavity 77 in a procedure similar to the above also when the second housing 60 is in a single state.

Subsequently, the second housing 60 is assembled with the first housing 10 from above such that the second facing surface 75 of the second housing main body 62 is arranged to face (opposite to) the first facing surface 15 of the first housing main body 12 (see FIGS. 1 and 5). In the process of assembling the first and second housings 10, 60, the lock projections 34 slide on the lock receiving portions 73 to deflect and deform the lock portions 13 outwardly and the bridging wall portions 37 slide on the fitting portions 74 to deflect and deform the bridge portions 14 outwardly.

When the first and second housings 10, 60 are properly assembled, the lock portions 13 resiliently return and the lock projections 34 are arranged to face and be lockable to the upper surface of the lock receiving portions 73 (see FIG. 3), and the bridge portions 14 resiliently return to be fitted to the fitting portions 74 and the bridging wall portions 37 are arranged to face the upper surface of the fitting portions 74 (see FIG. 2). At this time, the lock projections 34 of the lock portions 13 and the bridge portions 14 are fitted into the mounting recesses 72 and upper and rear parts thereof are protected by being covered by the ribs 71. Further, when the first and second housings 10, 60 are properly assembled, the lock main bodies 33 of the both lock portions 13 are arranged to project outwardly from peripheral parts of the both left and right side surfaces of the first and second housings 10, 60 (see FIG. 1). However, since being integrally coupled to the bridge portions 14, the both lock portions 13 are not easily opened and deformed even if an external matter or the like interferes from outside and a locked state of the lock portions 13 and the lock receiving portions 73 can be stably maintained.

When the first and second housings 10, 60 are assembled, the first and second covering walls 16, 76 are arranged in contact with each other and a part (rear end part) of the first covering wall 16 is arranged to be fitted into an open part between the second covering walls 76 (see FIG. 5). Further, when the first and second housings 10, 60 are assembled, the first and second locking lances 19, 79 face each other in a back-to-back state and arranged in contact along the front-back direction (see FIGS. 5 and 13). Specifically, the first and second locking lances 19, 79 are arranged in contact substantially over the entire lengths in the front-back direction, and the first and second locking surfaces 23, 83 are substantially aligned at the same position in the front-back direction and arranged continuously without any step in the vertical direction.

Further, the front end part of the first terminal fitting 11, the first locking lance 19, the front end part of the second terminal fitting 61 and the second locking lance 79 are arranged side by side substantially without any clearance in a vertical range of the first and second cavities 17, 77 (see FIG. 5). Thus, a resilient displacement of the first locking lance 19 in a direction to release the locking with the first terminal fitting 11 (upward) is regulated by the second locking lance 79, and a resilient displacement of the second locking lance 79 in a direction to release the locking with the second terminal fitting 61 (downward) is regulated by the first locking lance 19. As just described, when the first and second housings 10, 60 are assembled, the first terminal fitting 11 is substantially triply locked by the first and second locking lances 19, 79 and the second retaining portion 91 and the second terminal fitting 61 is substantially triply locked by the first and second locking lances 19, 79 and the first retaining portion 31.

Further, the first locking surface 23 of the first locking lance 19 is arranged to face and be lockable to the front end part of the first terminal fitting 11, whereby a long shear distance can be ensured in a range from the first locking surface 23, which is the projecting end of the first locking lance 19, to a position beyond the first straight part 22. Similarly, a long shear distance can be ensured in a range from the second locking surface 83 of the second locking lance 79 to a position beyond the second straight part 82. Thus, even if a pull-out force acts on the first or second terminal fitting 11, 61 such as by the wire 110, 160 being pulled backwardly, the first or second locking lance 19, 79 is prevented from being sheared and the state of the first or second locking lance 19, 79 locking the first or second terminal fitting 11, 61 is stably maintained.

Subsequently, the first and second housings 10, 60 in the above assembled state are connected to the mating housing 100 (see FIG. 4). At this time, an operator can perform a connecting operation while placing fingers on the exposed surfaces 35 of the both lock main bodies 33 and gripping the exposed surfaces 35 of the both lock main bodies 33 from opposite left and right sides. Since the exposed surfaces 35 of the both lock main bodies 33 are arranged to project from the surrounding parts of the both left and right side surfaces of the first and second housings 10, 60, they can be easily recognized by the operator and the both lock main bodies 33 can be gripped in preference to other parts.

When the first and second housings 10, 60 are properly connected to the mating housing 100, the both bridge portions 14 enter the receptacle 101 of the mating housing 100, but the both lock portions 13 are arranged to be exposed to the outside of the mating housing 100 (see FIG. 4). Thus, fingers can be placed on the exposed surfaces 35 of the both lock portions 13 all the time until the first and second housings 10, 60 are properly connected to the mating housing 100. Further, when the first and second housings 10, 60 are properly connected to the mating housing 100, the front ends of the both ribs 71 and those of the lock main bodies 33 of the both lock portions 13 are arranged to face proximately and in parallel to the opening end of the receptacle 101.

In withdrawing the first and second terminal fittings 11, 61 from the first and second housings 10, 60 for various reasons such as maintenance, the first and second housings 10, 60 need to be first separated from the mating housing 100. At this time, the locking state of the lock arm 63 is released by pressing the releasing portion 67 and, thereafter, the first and second housings 10, 60 are pulled apart from the mating housing 100 while fingers are placed on the exposed surfaces 35 of the both lock main bodies 33.

Subsequently, the locked state of the both lock portions 13 and the both lock receiving portions 73 is released and the first and second housings 10, 60 are pulled apart from each other and returned to the single state. Subsequently, the first and second terminal fittings 11, 61 respectively accommodated in the first and second cavities 17, 77 of the first and second housings 10, 60 are withdrawn. A withdrawing operation of the second terminal fitting 61 is described below.

In withdrawing the second terminal fitting 61, the substantially L-shaped or T-shaped bar-like jig 200 (cross-sectional shape of a tip part is shown in FIGS. 14A and 14B) may be used although not shown in detail. The jig 200 is inserted into the second cut portion 84 through an opening part of the second cut portion 84 on the second facing surface 75 of the second housing 60 and twisted substantially 90° in the second cut portion 84 and the tip part of the jig 200 is arranged to face and be capable of contacting the inner surface of the rear end part of the second locking lance 79 (see FIG. 14A).

In that state, the tip part of the jig 200 is slid along the second guide edge 85 (see FIG. 14B). At this time, the jig 200 is slid from the second rear edge part 86 to the second front edge part 87 via the second oblique edge part 88 and a part opposite to that sliding side is slid from the second inclined part 81 to the second straight part 82 of the second locking lance 79. By sliding the jig 200 from the side of the supporting point of deflection of the second locking lance 79 toward the free end side along the second guide edge 85 in this way, the second locking lance 79 is pressed by the jig 200 and gradually deflected and deformed in a direction to release the locking with the second terminal fitting 61. Since an operation force is not directly applied to the second locking lance 79 in its deflecting direction in this case, a situation where the second locking lance 79 is excessively deflected and deformed can be prevented.

Thereafter, when the jig 200 comes into contact with the second stopper edge 89, the locked state of the second locking lance 79 and the second terminal fitting 61 is released with an advancing movement of the jig 200 regulated and the second locking lance 79 deflected and deformed in a proper deflection range. In this way, the second terminal fitting 61 is permitted to be withdrawn from the second cavity 77 and can be pulled out from the second cavity 77. Note that, in the case of the first terminal fitting 11, a similar operation may be performed by respectively replacing the second terminal fitting 61 by the first terminal fitting 11, the second cut portion 84 by the first cut portion 24, the second guide edge 85 by the first guide edge 25, the second rear edge part 86 by the first rear edge part 26, the second oblique edge part 88 by the first oblique edge part 28, the second front edge part 87 by the first front edge part 27, the second locking lance 79 by the first locking lance 19, the second inclined part 81 by the first inclined part 21, the second straight part 82 by the first straight part 22 and the second stopper edge 89 by the first stopper edge 29 in the description of the above withdrawing operation of the second terminal fitting 61.

As described above, according to this embodiment, partition walls partitioning between deflection spaces for the first and second locking lances 19, 79 can be eliminated and the first and second housings 10, 60 can be respectively miniaturized (reduced in height) by that much since the first and second locking lances 19, 79 are provided to be exposed on the first and second facing surfaces 15, 75 that are the outer surfaces of the first and second housings 10, 60. Further, since the first and second locking lances 19, 79 are arranged to be capable of contacting each other back-to-back when the first and second housings 10, 60 are assembled, the entire connector can also be miniaturized.

Further, the first and second locking lances 19, 79 can be respectively smoothly deflected and deformed in the direction to release the locking with the first and second terminal fittings 11, 61 and excessive deflection of the first and second locking lances 19, 79 can be avoided (see FIG. 14B) by inserting the jig 200 through the opening parts on the first and second facing surfaces 15, 75, twisting the jig 200 and sliding the jig 200 along the first and second guide edges 25, 85 of the first and second cut portions 24, 84. As a result, the breakage of the first and second locking lances 19, 79 can be prevented.

Further, since the completion of a sliding operation of the jig 200 is notified to the operator by the sliding operation being stopped by the first and second stopper edges 29, 89, a lock releasing operation of the first and second locking lances 19, 79 can be reliably stopped before the first and second locking lances 19, 79 are excessively deflected.

Further, since the inner surfaces (surfaces facing the first and second cavities 17, 77) of the front end parts of the first and second locking lances 19, 79 are continuous without any step and include the first and second locking surfaces 23, 83 configured to lock the first and second terminal fittings 11, 61 on the front ends of the first and second locking lances 19, 79, the long shear distances along the withdrawing direction of the first and second terminal fittings 11, 61 can be ensured. As a result, even if the first and second locking lances 19, 79 become smaller as the first and second housings 10, 60 are miniaturized, a situation where the first and second locking lances 19, 79 are sheared and broken can be prevented.

Further, since the first and second locking lances 19, 79 come into contact with each other and the first and second locking surfaces 23, 83 are arranged to be continuous and flush in the vertical direction when the first and second housings 10, 60 are assembled, there is no step between the first and second locking surfaces 23, 83 and it can be prevented that an external matter is caught by the front ends of the first and second locking lances 19, 79.

Further, since the lock portions 13 have both a function of maintaining the assembled state of the first and second housings 10, 60 by locking the lock receiving portions 73 and a function as parts where fingers are placed in connecting the first and second housings 10, 60 to the mating housing 100, the configuration can be simplified as compared to the case where the both functions are separately provided.

Further, since the lock main bodies 33 of the lock portions 13 have such a thickness as to face the opening end of the receptacle 101 during connection to the mating housing 100 and the end surfaces of the lock main bodies 33 in a thickness direction serve as the exposed surfaces 35, the exposed surfaces 35 of the lock main bodies 33 can be easily recognized as finger placing surfaces in performing the connecting and separating operations to and from the mating housing 100.

Furthermore, since the bridge portions 14 are integrally mounted between the lock portions 13 and the first housing main body 12, inadvertent widening of the lock portions 13 can be suppressed by the bridge portions 14, the rigidity of the lock portions 13 can be enhanced and the assembled state of the first and second housing 10, 60 can be stably maintained.

Other embodiments are briefly described below.

An anti-slip portion may be provided on the exposed surface of the lock portion. The anti-slip portion may be configured, for example, by juxtaposing a multitude of convex and concave stripes on the exposed surface.

Slight clearances may be formed between the first and second locking lances when the first and second housings are assembled.

The invention in which the first and second cut portions are provided on the first and second partition walls is applicable also to a single housing which is not distinguished as a first or second housing.

The lock portions may be provided on the second housing and the lock receiving portions may be provided on the first housing.

### LIST OF REFERENCE SIGNS

10 . . . first housing (housing)
11 . . . first terminal fitting (terminal fitting)
13 . . . lock portion
14 . . . bridge portion
15 . . . first facing surface (facing surface)
17 . . . first cavity (cavity)
18 . . . first partition wall (partition wall)
19 . . . first locking lance (locking lance)
23 . . . first locking surface (locking surface)
24 . . . first cut portion (cut portion)
25 . . . first guide edge (guide edge)
29 . . . first stopper edge (stopper edge)
35 . . . exposed surface
60 . . . second housing (housing)
61 . . . second terminal fitting (terminal fitting)
73 . . . lock receiving portion
75 . . . second facing surface (facing surface)
77 . . . second cavity (cavity)
78 . . . second partition wall (partition wall)
79 . . . second locking lance (locking lance)
83 . . . second locking surface (locking surface)
84 . . . second cut portion (cut portion)
85 . . . second guide edge (guide edge)
89 . . . second stopper edge (stopper edge)
100 . . . mating housing
101 . . . receptacle
200 . . . jig

What is claimed is:

1. A connector, comprising two housings to be assembled in a mutually laminated state, wherein:
the both housings respectively include facing surfaces facing each other at the time of assembling and are connectable to and separable from a mating housing in an assembled state;
one housing out of the both housings includes deflectable lock portions provided on opposite sides intersecting with the facing surface;
the other housing out of the both housings includes lock receiving portions provided on opposite sides intersecting with the facing surface and configured to maintain the assembled state of the both housings by being resiliently locked from outer sides by the lock portions; and
the lock portions include exposed surfaces exposed to outside with the both housings connected to the mating housing and enabling fingers to be placed thereon during connection to and separation from the mating housing.

2. The connector of claim 1, wherein:
the mating housing includes a receptacle externally fittable to the both housings; and
the lock portions have such a thickness as to face an opening end of the receptacle with the both housings connected to the mating housing and end surfaces in a thickness direction serves as the exposed surfaces.

3. The connector of claim 1 or 2, wherein:
the lock portions are arranged on a rear end part of the one housing in a connecting direction of the both housings; and
the one housing includes bridge portions linking a front end part of the one housing in the connecting direction of the both housings and projecting end parts of the lock portions.
